(19) United States
(12) Patent Application Publication
(10) Pub. No.: US 2005/0098757 A1
(43) Pub. Date: May 12, 2005

(54) Leak-proof gate valve

(76) Inventor: Richard C.C. Chao, Taipei (TW)

Correspondence Address: BIRCH STEWART KOLASCH & BIRCH, PO BOX 747, FALLS CHURCH, VA, 22040-0747, US

(21) Appl. No.: 10/701,568

(22) Filed: Nov. 6, 2003

(51) Int. Cl. F16K 31/00

(52) U.S. Cl. 251/349

(57) ABSTRACT

A leak-proof gate valve adapted for use on inflatable goods includes a stem which has a through hole in the center and a valve seat which has a round strut. When inflation reaches a desired condition, the stem may be pushed towards the valve seat to couple the through hole and the round strut tightly and cut off the fluid passage to prevent gas leakage. For deflation, pull the stem rearwards, and the through hole and the round strut form a gap to form a gas passage. Thus the gate valve is leak-proof and more convenient for use.

### FIELD OF THE INVENTION

The present invention relates to a gate valve and particularly to a gate valve equipped with an improved leak-prevention effect without affecting gas intake or discharge operation.

### BACKGROUND OF THE INVENTION

Referring to FIG. 1, the conventional gate valve is widely used on inflatable goods. To prevent the inflatable goods from leaking through the gate valve, the gate valve is usually designed as an one way check valve which is openable only inwards. Once inflated, the pressure difference resulting from the ambience pushes the one way gate valve inwards. Such a design has a drawback. Namely, when the interior pressure is greater than the inflating pressure, the gate valve cannot be opened, and inflation has to be stopped. For deflation, a bar type article has to be used to push the gate valve inwards to form an air passage for discharging the gas filled in the inflated goods.

U.S. Pat. No. 4,456,028 discloses a relief gate valve which has a port formed on the bottom of the valve. Air may enter through the port for inflation or be discharged for deflation. The stem has screw threads on the periphery and has an upper end coupled with an embossed screw sleeve. The stem has a bottom flange to couple tightly with the port of the bottom of the valve seat. The valve seat has internal screw threads formed on the inner wall to couple with the screw threads of the stem periphery thereby enables the stem to move relative to the valve seat. To open or close the gate valve, the stem must be turned. It is not convenient when in use.

### SUMMARY OF THE INVENTION

The primary object of the invention is to provide a leak-proof gate valve that prevents inflation effect from being compromised and avoids causing inconvenience to users.

The invention mainly includes a valve cap, a stem running through the center of the valve cap and a valve seat coupling with the valve cap. The valve cap has an opening in the center to allow the stem to pass through and couple tightly. The stem has one end forming a round duct to connect to a connection tube for conveying gas and another end forming a coupling section. The coupling section has a through hole in the center communicating with the round duct. The coupling section is tightly coupled with the valve cap and the valve seat to form an airtight condition. The valve seat has a round strut in the center and a vent to communicate with the through hole of the stem to form a gas passage.

By means of the improved structure set forth above, the air tightness of the gate valve may be improved, and operation of the gate valve is simplified.

### BRIEF DESCRIPTION OF THE DRAWINGS

FIG. 1 is a cross sectional view of a conventional gas inlet valve.

FIG. 2 is a perspective view of a preferred embodiment of the present invention.

FIG. 3 is an exploded view of the preferred embodiment of the present invention.

FIG. 4A is a schematic view of the embodiment of the invention in an operating condition.

FIG. 4B is a schematic view of the embodiment of the invention in another operating condition.

FIG. 5 is a pictorial view of the embodiment of the invention in use.

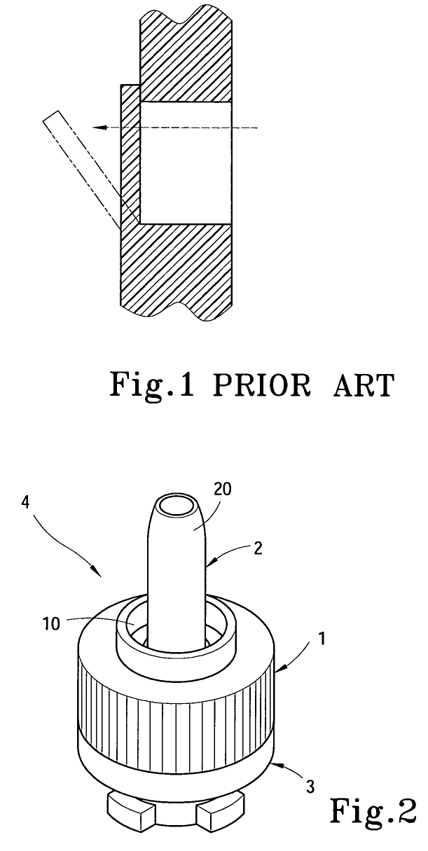

### DETAILED DESCRIPTION OF THE PREFERRED EMBODIMENT

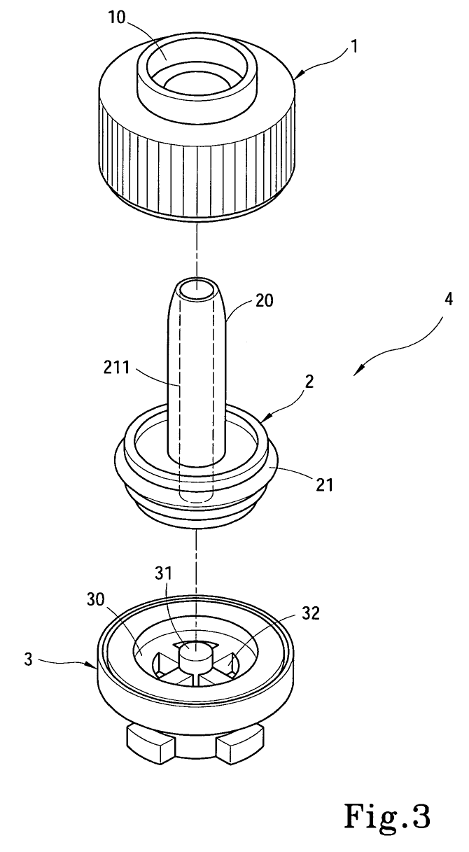

Please refer to FIG. 2, the gate valve 4 according to the invention mainly includes a valve cap 1, a stem 2 running through the center of the valve cap 1 and a valve seat 3 coupling with the valve cap 1. The valve cap 1 has an opening 10 in the center to allow the stem 2 to pass through and couple tightly. The stem 2 has one end forming a round duct 20 as shown in FIG. 3 to connect to a connection tube for conveying gas from outside and another end forming a coupling section 21 which has a cross section formed in a stepwise manner. The coupling section 21 has a through hole 211 in the center communicating with the round duct 20. The coupling section 21 may be coupled with an indented coupling surface 30 of the valve seat 3 to form a double airtight sealing. The coupling surface 30 has a round strut 31 in the center. The valve seat 3 has a vent 32 at the bottom.

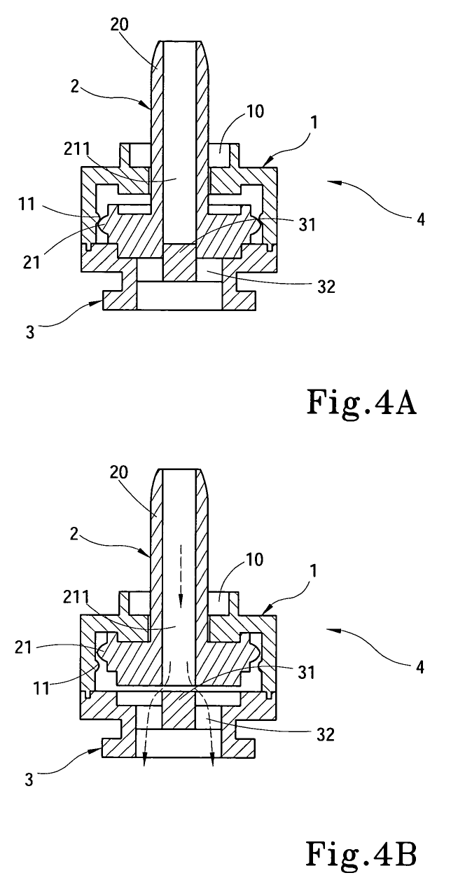

Referring to FIGS. 4A and 4B, for inflation, pull the stem 2 rearwards to a second position as shown in FIG. 4B. The stem 2 and the valve seat 3 form a gas passage. When inflation reaches a desired condition, the stem 2 may be pushed forwards to a first position as shown in FIG. 4A. The stem 2 and the round strut 31 of the valve seat 3 are coupled tightly. The valve cap 1 has a bulged ring 11 formed therein to couple with the coupling section 21. The bulged ring 11 may also be formed in an indented groove to couple with the coupling section 21 to form an airtight condition. When the stem 2 is moved between the first and the second position, the coupling of the coupling section 21 and the bulged ring 11 will generate a click sound to enable users to recognize that the stem 2 is switched to an anchor position. When the stem 2 is pushed and anchored, the through hole 211 of the coupling section 21 and the round strut 31 of the valve seat 3 are coupled tightly. Thus gas leakage may be prevented. Moreover, opening and closing of the gate valve 4 is more convenient than the conventional ones. It can be opened or closed by simply pulling and pushing the stem 2.

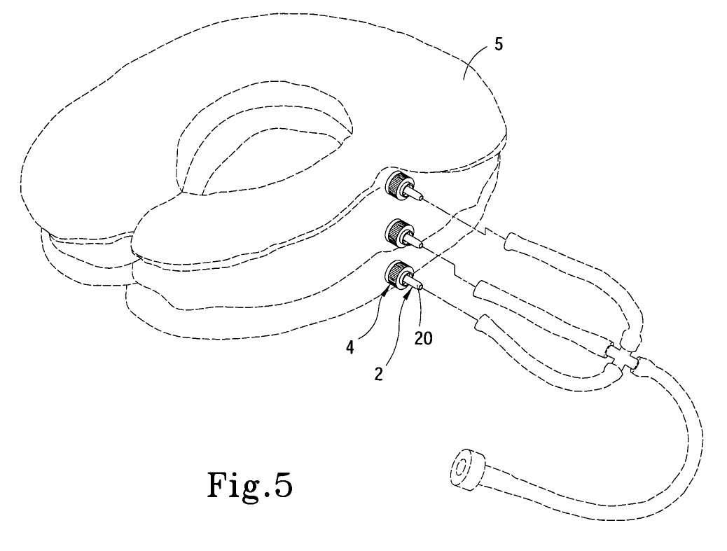

Refer to FIG. 5 for the gate valve 4 of the invention adapted for use on a multi-layer inflation bracing object 5. For inflation, move the stem 2 to the second position as shown in FIG. 4B. The gate valve 4 forms a gas passage. When inflation reaches a desired condition, push the stem 2 to the first position as shown in FIG. 4A, which is in an airtight condition. When the connection tube is removed, the bracing object 5 may be used without gas leaking. When user use the bracing object 5 smoothly without the connection tube.

1. A leak-proof gate valve adapted for use on inflatable goods, comprising:
a valve cap which has an opening in the center;
a stem running through the opening of the valve cap to form a tight coupling therewith; and
a valve seat coupling with the valve cap;
wherein the valve cap further has a bulged ring formed in the interior thereof, the stem having one end formed a coupling section which has a stepwise cross section and a through hole in the center, the valve seat having an indented coupling surface and a round strut in the center of the coupling surface to tightly couple with the coupling section such that the stem is movable by pushing and pulling to adjust opening and closing operations of the gate valve.

2. The leak-proof gate valve of claim 1, wherein the coupling section is allowed to couple tightly with the bulged ring of the valve cap.

3. The leak-proof gate valve of claim 1, wherein the coupling section is movable between a first position and a second position of the valve cap.

4. The leak-proof gate valve of claim 3, wherein the first position is the coupling section moved below the bulged ring of valve cap.

5. The leak-proof gate valve of claim 3, wherein the second position is the coupling section moved above the bulged ring of valve cap.

6. The leak-proof gate valve of claim 3, wherein the gate valve is closed when the coupling section is at the first position.

7. The leak-proof gate valve of claim 3, wherein the gate valve is open when the coupling section is at the second position.

8. The leak-proof gate valve of claim 1, wherein the bulged ring of the valve cap is formed in an indented groove to couple with the coupling section.
